(19) United States
(12) Patent Application Publication
(10) Pub. No.: US 2001/0036265 A1
(43) Pub. Date: Nov. 1, 2001

(54) Automatic opening and closing apparatus for mobile phones

(76) Inventor: Pu Hyun Oh, Kyungsangnam-do (KR)

Correspondence Address: BIRCH STEWART KOLASCH & BIRCH, PO BOX 747, FALLS CHURCH, VA, 22040-0747, US

(21) Appl. No.: 09/840,154

(22) Filed: Apr. 24, 2001

(30) Foreign Application Priority Data
Apr. 24, 2000 (KR) 2000-21673

(51) Int. Cl. H04M 1/00

(52) U.S. Cl. 379/433.01

(57) ABSTRACT

Disclosed herewith is an opening and closing apparatus for mobile phones. The opening and closing apparatus includes a hollow case fixedly attached to the lower portion of the cover of a mobile phone. A hollow shaft is fixedly attached to the upper portion of the body of the mobile phone and rotatably inserted into the case. An actuator is inserted into the hollow shaft to be movable through the hollow shaft. A control cam is fitted over the front end of the actuator to allow the actuator to be rectilinearly movable by a predetermined distance. A slide cam is fitted over the shaft to be rectilinearly moved and to be rotated, and situated in the case to be rectilinearly moved but not to be rotated relative to the case. Elastic means is provided to push the slide cam toward the control cam. A rotary cam is situated between the slide and control cams, and fitted over the shaft to be movable but not to be rotatable relative to the shaft. When the actuator is pushed and moved through the shaft, the contact positions among the slide, rotary and control cams are changed, thereby allowing the cover to be opened.

### BACKGROUND OF THE INVENTION

1. Field of the Invention

The present invention relates generally to mobile phones, and more particularly to an automatic opening and closing apparatus for mobile phones, which allows its cover to be automatically opened from its body when its push button is operated, and which allows its cover to be kept tightly closed over its body when the cover is closed.

2. Description of the Prior Art

FIG. 1 is a plan view showing a conventional folding type mobile phone with its cover being opened.

In general, the conventional folding type mobile phone is comprised of a body 1 provided with a plurality of dial buttons 2 and a voice transmitter 3, a cover 4 provided with a voice receiver 5, and a hinge 6 rotatably connecting the body 1 and the cover 4. A liquid crystal monitor 7 is formed on the cover 4.

A user makes a phone call while the cover 4 is opened, while the user makes the phone stand by when the cover 4 is closed after a phone call.

However, the conventional mobile phone causes a user inconvenience in that its cover 4 has to be opened and closed by hand. Additionally, the cover 4 is not stably opened and closed, so the cover 4 is easily closed and opened by a small external impact, thereby causing a problem that a call is disconnected.

### SUMMARY OF THE INVENTION

Accordingly, the present invention has been made keeping in mind the above problems occurring in the prior art, and an object of the present invention is to provide an automatic opening and closing apparatus for mobile phones that is capable of allowing its cover to be automatically opened by the pushing of its push button.

Another object of the present invention is to provide an automatic opening and closing apparatus for mobile phones, which is capable of allowing its cover to be automatically closed when the cover is rotated at a predetermined angle and which is capable of allowing its cover to be kept tightly closed after the cover is closed.

In order to accomplish the above object, the present invention provides a opening and closing apparatus for mobile phones, comprising: a hollow case fixedly attached to the lower portion of the cover of a mobile phone; a hollow shaft fixedly attached to the upper portion of the body of the mobile phone and rotatably inserted into the case; an actuator inserted into the hollow shaft to be movable through the hollow shaft; a control cam fitted over the front end of the actuator to allow the actuator to be rectilinearly movable by a predetermined distance; a slide cam fitted over the shaft to be rectilinearly moved and to be rotated, and situated in the case to be rectilinearly moved but not to be rotated relative to the case; elastic means for pushing the slide cam toward the control cam; and a rotary cam situated between the slide and control cams, and fitted over the shaft to be movable but not to be rotatable relative to the shaft; wherein when the actuator is pushed and moved through the shaft, the contact positions among the slide, rotary and control cams are changed, thereby allowing the cover to be opened.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a plan view showing a conventional folding type mobile phone with its cover being opened;

FIG. 2 is an exploded perspective view showing an opening and closing apparatus for mobile phones in accordance with the present invention;

FIG. 3 is a cross section showing the automatic hinge assembly of the opening and closing apparatus;

FIG. 4 is an exploded perspective view of the automatic hinge assembly; and

FIGS. 5a to 7b are views showing the operation of the opening and closing apparatus,

FIG. 5a is a cross-section showing the state in which the cover is closed,

FIG. 5b is a development view showing the operation of cams when the cover is closed,

FIG. 6a is a cross-section showing the state in which the cover is opened,

FIG. 6b is a development view showing the operation of cams when the cover is opened,

FIG. 7a is a cross-section showing the state in which the cover has been completely opened, and

FIG. 7b is a development view showing the operation of cams when the cover has been completely opened.

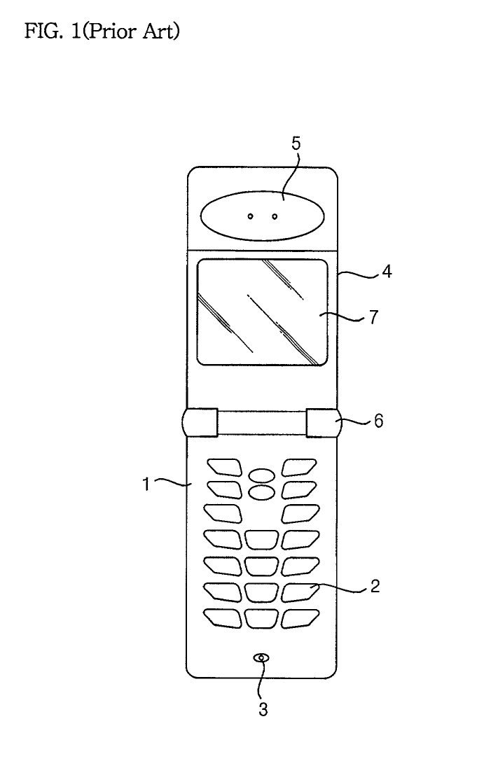

### DESCRIPTION OF THE PREFERRED EMBODIMENTS

Reference now should be made to the drawings, in which the same reference numerals are used throughout the different drawings to designate the same or similar components.

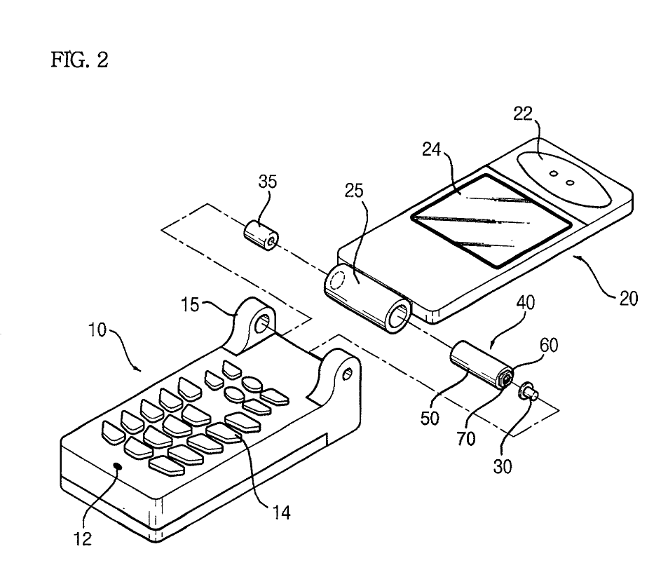

In an automatic opening and closing apparatus for mobile phones in accordance with the present invention, a phone body 10 and a cover 20, as illustrated in FIG. 2, are hingedly connected to each other so as to allow the cover 20 to be selectively opened and closed with regard to the phone body 10.

The phone body 10 is provided with a sound transmitter 12 and a plurality of dial buttons 14, and the cover 20 is provided with a sound receiver 22 and a liquid crystal monitor 24.

Two connecting projections 15 are formed on both sides of one end of the phone body 10, while a connecting cylinder 25 is formed on the central portion of one end of the cover 20. The phone body 10 and the cover 20 are hingedly connected to each other in such a way that the connecting projections 15 and the connecting cylinder 25 are rotatably connected to each other by a hinge pin 35 and an automatic hinge assembly 40.

The automatic hinge assembly 40 functions in such a way that the cover 20 is automatically opened when a push button 30 mounted on one side of one of the connecting projections 15 is pushed, while the cover 20 is brought into tight contact with the phone body 10 when the cover 20 is manually closed.

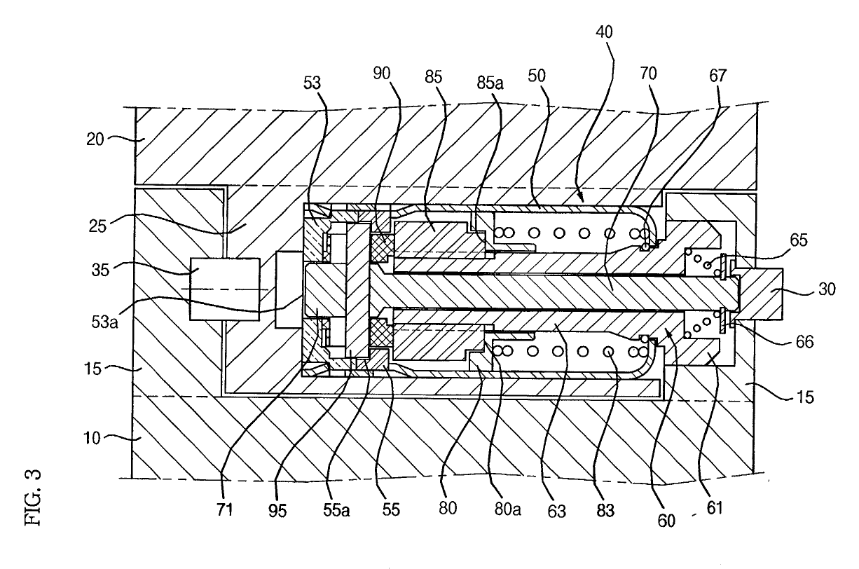

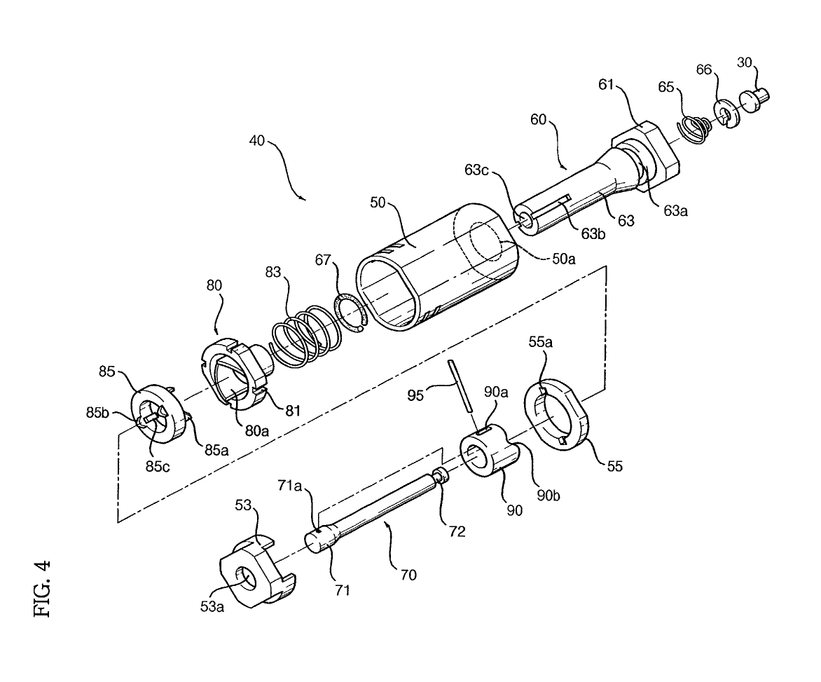

FIG. 3 is a cross section of the automatic hinge assembly, and FIG. 4 is an exploded perspective view of the automatic hinge assembly.

The automatic hinge assembly 40 is comprised of a hollow case 50 fixedly attached to the inner surface of the connecting cylinder 25 of the cover 20, and a shaft 60 secured at its one end to one connecting projection 15 of the phone body 10 and rotatably insertable into the case 50.

In order to prevent the case 50 from being rotated in the connecting cylinder 25, at least one portion of the inner surface of the connecting cylinder 25 and at least one portion of the case are made flat, thereby causing the cross-section of the case 50 to be non-circular. One surface of the case 50 is provided with a hole 50a so as to receive the shaft 60, and the other surface of the case 50 is completely open.

One end of the shaft 60 is squarely shaped and fitted into one connecting projection 15. A circular groove 63a is formed on the shaft body 63 beside the squarely shaped end, and a snap ring 67 is fitted around the circular groove 63a to prevent the axial movement of the shaft 60 in the case 50.

A longitudinal center hole 63c is formed through the shaft 60, and an actuator 70 rectilinearly movable by the operation of the push button 30 is inserted into the longitudinal center hole 63c.

The actuator 70 has a length to allow its both ends to be exposed to the outside when it is inserted into the central hole 63c of the shaft 60. A circular groove 72 is formed on one end of the actuator 70 to allow a washer 66 to be mounted therein, and a thick portion 71 is formed on the other end of the actuator 70 to have an outer diameter so as to prevent the thick portion 71 from being inserted into the center hole 63c of the shaft 60.

The actuator 70 is forcibly pushed toward the push button 30 by a return spring 65 situated between the shaft 60 and the washer 66.

A slide cam 80 is fitted over the shaft body 63 of the shaft 60 to be axially movable in the case 50 but not to be rotatable relative to the case 50, and a rotary cam 85 is fitted over the shaft body 63 of the shaft 60 to be rotatable and to be axially movable in the case 50.

A plurality of axial grooves 81 are formed along the outer surface of the slide cam 80, and a plurality of projections (not shown) formed on the inner surface of the case 50 are engaged with the axial grooves 81, thereby preventing the slide cam 80 from being rotated relative to the case 50. The slide cam 80 is rotatably fitted over the shaft 60, and pushed toward the rotary cam 85 by a cam spring 83 mounted in the case 50.

A plurality of axial projections 85c are formed on the inner surface of the rotary cam 85, and a plurality of axial grooves 63b formed on the outer surface of the shaft body 63 of the shaft 63 are engaged with the axial projections 85c, thereby preventing the rotary cam 85 from being rotated relative to the shaft 60.

Two spiral cam surfaces 80a and 85a, which are projected toward each other and provide automatic opening and closing functions according to predetermined positions, are formed on the slide and rotary cams 80 and 85, respectively.

A pair of axial projections 85b are axially projected from the rotary cam 85 in the direction opposite to the spiral cam surface 85a, and spaced apart from each other by 180°.

A control cam 90, which is provided with a cam surface 90b that is brought into contact with the axial projections 85b of the rotary cam 85, is fitted over the thick portion 71 of the actuator 70.

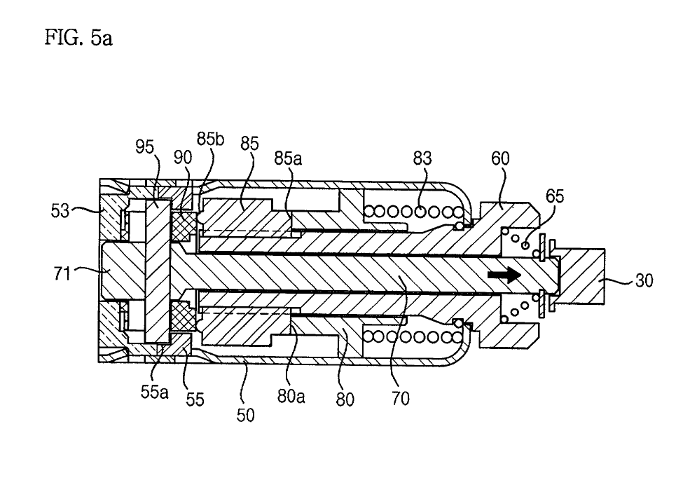

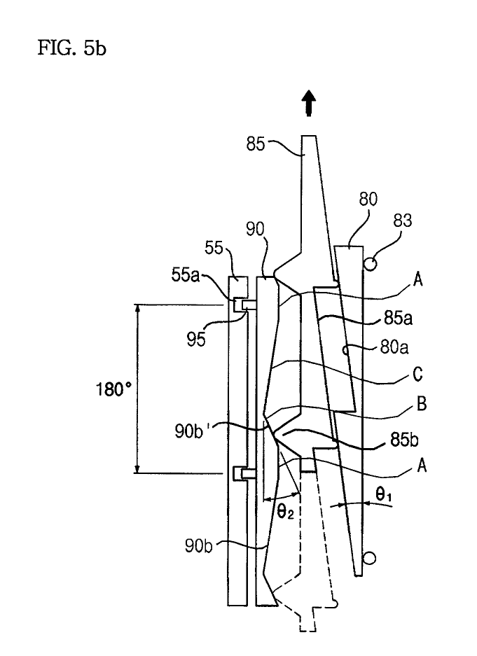

With reference to FIG. 5b, the cam surface 90b of the control cam 90 is formed by a projected surface A, a steeply sloped surface B and a gradually sloped surface C.

The inclined angle θ₂ of the steeply sloped surface B is formed to be greater than the inclined angle θ₁ of the spiral cam surface 80a of the cam surface 80, thus providing force to allow the cover 20 to be automatically closed when the cover 20 is rotated at a predetermined angle.

Two slits 90a are formed through the control cam 90, and a hole 71a is formed through the thick portion 71 of the actuator 70. A locking pin 95 is tightly fitted into the hole 71a of the actuator 70 through the slit 90a of the control cam 90, thereby engaging the control cam 90 with the actuator 70 and allowing them to be rotated together.

The slit 90a of the control cam 90 has an axial length to allow the control cam 90 to be moved relative to the actuator 70 to a certain extent.

A stopper 55 secured to the case 50 is situated between the control cam 90 and the case 100. Two recesses 55a are formed on one surface of the stopper 55 and spaced apart from each other by 180° so as to receive both ends of the locking pin 95 projected from the control cam 90.

A cap 53 is tightly fitted into the open end of the case 50 so as to prevent parts, such as the stopper 55, from being removed. A hole 53a is formed on the cap 53 so as to allow the thick portion 71 of the actuator 70 to pass through the cap 53.

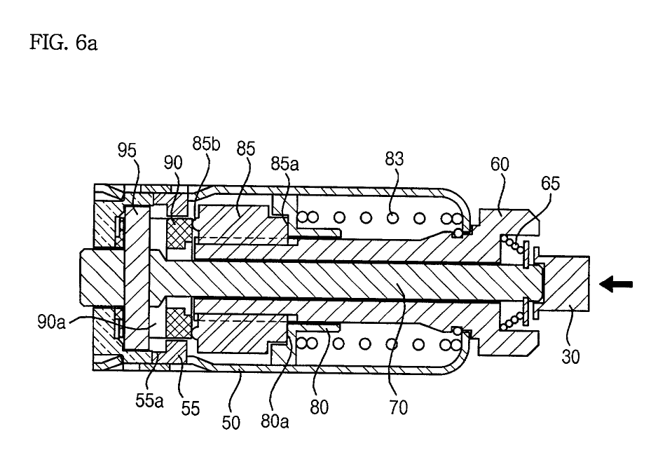

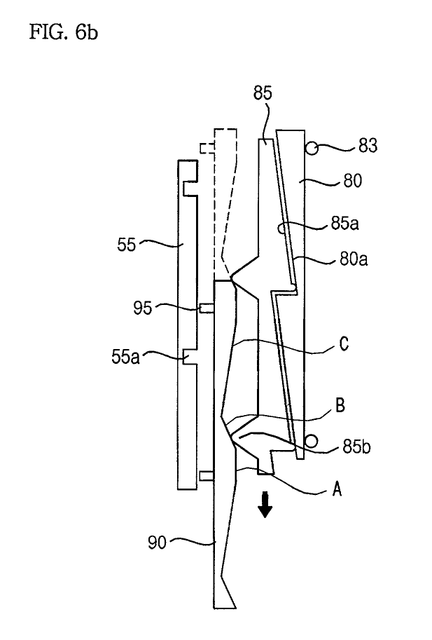

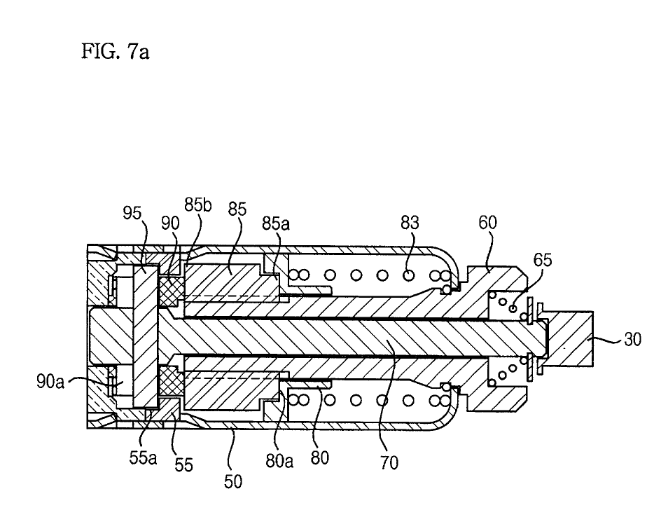

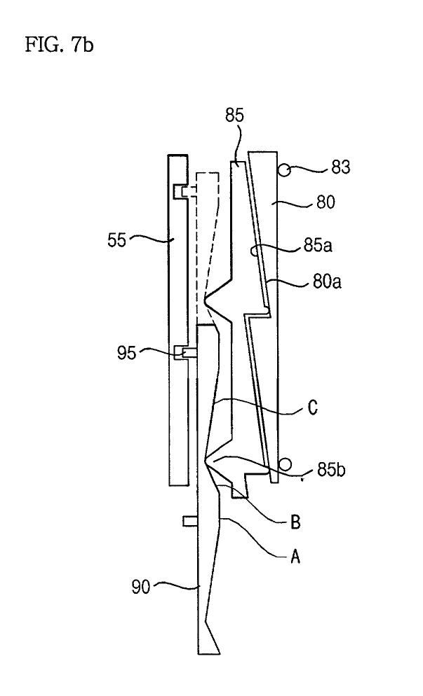

FIGS. 5a to 7b are views showing the operation of the automatic opening and closing apparatus for mobile phones. FIGS. 5a and 5b are views showing the state in which the cover is closed. FIGS. 6a and 6b are views showing the state in which the cover is opened. FIGS. 7a and 7b are views showing the state in which the cover has been completely closed.

While the cover 20 is closed over the phone body 10, the actuator 70, as shown in FIG. 5a, has been moved toward the push button 30 by the elastic force of the return spring 65, and the spiral cam surfaces 80a and 85a of the slide and rotary cams 80 and 85, as shown in FIG. 5b, are brought into contact with each other at their outermost positions.

At that time, the locking pin 95 extended through the control cam 90 is inserted into the recesses 55a formed on the stopper 55, and the cover 20 is stably closed over the phone body 10 by the elastic force of the return spring 65 while the axial projections 85b of the rotary cam 85 are brought into contact with the center portion of the steeply sloped surface B of the control cam 90.

Since the angle 02 is larger than the angle θ₁, rotating force is exerted on the rotary cam 85 in the arrow direction of FIG. 5b. Accordingly, rotating force is exerted on the shaft 61 and the phone body 10 secured to the shaft 61 in the same direction as that of the rotary cam 85, thereby keeping the cover 20 stably closed over the phone body 10.

When the push button 30 is pushed while the cover 20 is closed, the actuator 70, as shown in FIGS. 6a and 6b, is pushed by the push button 30 and the locking pin 95 tightly fitted into the actuator 70 is rectilinearly moved and removed from the recesses 55a of the stopper 55, thereby allowing the control cam 90 to be rotatable.

At that time, the elastic force of the cam spring 83 acts toward the slide cam 80 while the spiral cam surfaces 85a and 80a and the rotary and slide cams 85 and 80 are brought into contact with each other at their outermost positions, so the spiral cam surfaces 85a and 80a are forced to be in the state in which they are brought into contact with each other at their innermost positions.

In such a state, as the locking pin 95 is moved along the slit 90a of the control cam 90 and is removed from the stopper 55, the control cam 90 is caused to be rotatable. At the same time, the rotary cam 85 can perform rotational movement that is regulated by the control cam 90, so the rotary cam 85 is forced to be rotated in the arrow direction of FIG. 6b by the force that tends to bring the spiral surfaces 85a and 80a into contact with each other at their innermost positions.

In this case, since a user holds the phone body 10, the rotary cam 85 cannot be rotated but the slide cam 80 is rotated. Accordingly, the case 50 and the cover 20 are rotated, so the cover 20 is opened from the phone body 10.

Simultaneously, as shown in FIGS. 7a and 7b, as the steeply sloped surface B of the control cam 90 is slid over the projections 85b of the rotary cam 85 and the projections 85b are situated at the innermost positions of the control cam 90, the locking pin 95 extended through the slit 90a of the control cam 90 is rotated at 180°, together with the control cam 90. In this case, when the push button 30 is released, both ends of the locking pin 95 are inserted into and held in the recesses 55a of the stopper 55, thereby allowing the cover 20 to be kept stably closed.

When the cover 20 is closed over the phone body 10 while the cover is opened, the slide cam 80 is rotated with the rotation of the case 50 secured to the connecting cylinder 25 of the cover 20 and the locking pin 95 and the control cam 90 are rotated with the rotation of the stopper 55 secured to the case 50. In such a case, the axial projections 85b of the rotary cam 85 are moved from the gradually sloped surface C through the projected portion A to the steeply sloped surface B, and the spiral cam surfaces 85a and the 80a of the rotary and slide cams 85 and 80 are brought into contact with each other at their outermost positions.

While the axial projections 85b of the rotary cam 85 are situated on the steeply sloped surface B of the control cam 90, the inclined angle θ₁ of the spiral cam surface 80a of the slide cam 80 is less than the inclined angle θ₂ of the steeply inclined surface B of the control cam 90, thus allowing the cover 20 to be tightly closed over the phone body 10 and keeping the cover 20 stably closed over the phone body 10.

When a user manually opens the cover 20, the control cam 90 is rotated while being fixed to the case 50 by the engagement of the locking pin 95 and the stopper 55. The contact position between each projection 85b of the rotary cam 85 and the control cam 90 is changed from the steeply sloped surface B through the projected portion A to the gradually sloped surface C. When the cover 20 is manually opened slightly, the cover 20 is automatically opened by force that tends to cause the spiral cam surfaces 85a and 80a of the rotary cam 85 and the slide cam 80 to be brought into contact with each other at their innermost positions.

On the other hand, if the shaft 60 is mounted on the cover 20 and the case 50 is mounted over the phone body 10, the slide cam 80, the case 50 and the stopper 55 should not be rotated, while the shaft 60 and the rotary cam 85 should be rotated, so as to allow the cover 20 to be selectively opened and closed.

As described above, the present invention provides an automatic opening and closing apparatus for mobile phones, which is capable of opening its cover from its body when its push button is pushed. Additionally, when a user manually opens the cover, the cover is automatically opened by the slight opening thereof, thereby providing convenience in use to the user.

In accordance with the automatic opening and closing apparatus of the present invention, the cover is automatically closed when the cover is rotated over a predetermined angle. Additionally, while the cover has been completely closed, the cover is tightly closed over the phone body, thereby keeping the cover stably closed and, thus, eliminating a problem that the cover is undesirably opened.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An opening and closing apparatus for mobile phones, comprising:
a hollow case fixedly attached to the lower portion of the cover of a mobile phone;
a hollow shaft fixedly attached to the upper portion of the body of the mobile phone and rotatably inserted into said case;
an actuator inserted into said hollow shaft to be movable through said hollow shaft;
a control cam fitted over the front end of said actuator to allow said actuator to be rectilinearly movable by a predetermined distance;
a slide cam fitted over said shaft to be rectilinearly moved and to be rotated, and situated in said case to be rectilinearly moved but not to be rotated relative to said case;
elastic means for pushing said slide cam toward said control cam; and
a rotary cam situated between said slide and control cams, and fitted over said shaft to be movable but not to be rotatable relative to said shaft;
wherein when said actuator is pushed and moved through said shaft, the contact positions among said slide, rotary and control cams are changed, thereby allowing the cover to be opened.

2. The apparatus according to claim 1, further comprising a cap for restricting the rectilinear movement of said slide, rotary and control cams.

3. The apparatus according to claim 1, further comprising a spring, said spring being situated between said shaft and said actuator to push said actuator out of said shaft.

4. The apparatus according to claim 1, wherein said case is fixedly inserted into a connecting cylinder formed on the lower portion of said cover, and said shaft is secured to a connecting projection formed on one of both sides of the upper portion of said phone body.

5. The apparatus according to claim 4, further comprising another connecting projection, said connecting projection being formed on the other of both sides of the upper portion of said phone body and being hingedly connected to said connecting cylinder.

6. The apparatus according to claim 4, further comprising a push button, said push button being mounted to one connecting projection so as to move said actuator to allow said cover to be automatically opened by the removal of said locking pin from said stopper.

7. The apparatus according to claim 1, wherein said slide and rotary cams are provided with two spiral cam surfaces so that the cam surfaces are brought into contact with each other at their outermost positions while said cover is closed and the cam surfaces are brought into contact with each other at their innermost positions while said cover is opened, said rotary cam is provided at positions opposite to the position of its cam surface with one or more projections, and said control cam is provided with a cam surface that is brought in contact with the projections of the rotary cam and comprised of a projected surface, a steeply sloped surface and a gradually sloped surface.

8. The apparatus according to claim 7, wherein said projections of the rotary cam are formed to be brought into contact with said steeply sloped surface of the rotary cam while said cover is completely closed, and the inclined angle of said steeply sloped surface is formed to be greater than the inclined angle of the spiral cam surface of the slide cam so as to allow said cover to be kept tightly closed over said phone body.

9. The apparatus according to claim 7, wherein when a user slightly opens said cover, said cover is automatically and completely opened by force that tends to bring said spiral surfaces into contact with each other at their innermost positions in such a way that the portion of said control cam in contact with the projections of said rotary cam is changed from the steeply sloped surface through the projected surface to the gradually sloped surface.

10. The apparatus according to claim 7, wherein when a user slightly closes said cover, said cover is automatically and completely closed by force that tends to bring said spiral surfaces into contact with each other at their outermost positions in such a way that the portion of said control cam in contact with the projections of said rotary cam is changed from the gradually sloped surface through the projected surface to the steeply sloped surface.

11. The apparatus according to claim 1, wherein a locking pin is vertically extended through said actuator, said control cam is provided with a slit into which said locking pin is inserted and which allows the actuator and the locking pin to be moved by a predetermined distance, and a stopper is mounted to the inner end of said case so as to prevent said control cam from being rotated by the engagement of said locking pin when said cover is opened and closed.

12. The apparatus according to claim 11, wherein said stopper is shaped in the form of a ring, secured to the inner end of said case, and provided with two recesses for receiving both ends of side locking pin.
